(19) United States
(12) Patent Application Publication
(10) Pub. No.: US 2005/0102352 A1
(43) Pub. Date: May 12, 2005

(54) Constrained user interface in a communications network

(76) Inventors: Junbiao Zhang, Bridgewater, NJ (US); Jun Li, Plainsboro, NJ (US)

Correspondence Address: THOMSON LICENSING INC., PATENT OPERATIONS, PO BOX 5312, PRINCETON, NJ, 08543-5312, US

(21) Appl. No.: 10/253,283

(22) Filed: Sep. 24, 2002

(51) Int. Cl. G06F 15/16

(52) U.S. Cl. 709/203

(57) ABSTRACT

In a communications system (10), activation of a user interface (e.g., a hyperlink) to select an application depends on one or more conditions that might impact the application. Monitoring of the condition(s) occurs to determine whether each condition falls outside a corresponding threshold. If so, the interface is constrained, either partially or completely.

### TECHNICAL FIELD

This invention relates to a technique for controlling a user interface, such as a hyperlink, in accordance with one or more constraints.

### BACKGROUND ART

Currently, a variety of different wireless access networks exist. For example, subscribers can obtain both voice and data communication capability from wireless telephony network providers of TDMA, CDMA and GSM service. Some wireless telephony service providers now offer service in accordance with the UMTS-3GPP wireless telephony standard known in the art. Further, advances in the field of wireless LAN technology has resulted in the emergence of publicly accessible wireless LANs (e.g., “hot spots”) at rest stops, cafes, libraries and similar public facilities. Presently, wireless LANs offer users access to a private data network, such as a Corporate Intranet, or a public data network such as the Internet. The relatively low cost to implement and operate a wireless LAN, as well as the available high bandwidth (usually in excess of 10 Megabits/second) makes the wireless LAN an ideal access mechanism through which a mobile terminal user can exchange packets with an external source.

Given the various types of wireless networks that presently exist, a mobile terminal user can readily connect to different networks in different locations at different times. Each wireless network has a particular quality of Quality of Service (QoS) level and an associated access cost. The QoS level available in a particular network might not support a given application which the user wishes to access. A user that desires to execute a particular application that requires greater resources (i.e., a higher QoS level) than are available in the network currently providing access will encounter difficulties when attempting to execute that application. For example, a user seeking to execute an application containing streaming video in the absence of sufficient bandwidth available in the access network will suffer impaired performance of that application.

Presently, a user receives no advance indication of the inability of the network to support the selected application until the application actually executes. Despite unsatisfactory application performance, such as disappointing playback of streaming video, the mobile terminal user still incurs the access changes imposed by the wireless network service provider for execution of the selected application.

Thus, there is need for a technique that controls activation at least one user interface (e.g., a hyperlink) in accordance with certain constraints to prevent or at least limit activation in the absence of sufficient network resources in order to overcome the foregoing disadvantages.

### BRIEF SUMMARY OF THE INVENTION

Briefly, in accordance with present principles, there is provided a method for controlling the activation of at least one user interface, such as a hyperlink, via which a user executes a selected application. The method commences by monitoring at least one condition that might potentially impact application performance to determine whether the monitored condition remains within a threshold limit. Upon determining that the monitored condition does not remain within have the corresponding threshold limit, then the user interface is fully or partially constrained. When fully constrained, a user interface, such as a hyperlink, becomes disabled, thus completely preventing execution of the user selected application. In contrast to a complete constraint, a user can activate a partially constrained user interface, but only after some additional activity by the user, such as a confirming acceptance of potentially substandard execution of the desired application selection.

### BRIEF DESCRIPTION OF THE DRAWINGS

FIG. 1 depicts a block schematic diagram of a communications network for practicing the constrained user interface technique of the present principles; and

FIG. 2 depicts in flow chart form the steps of the method of the present principles for constraining a user interface.

### DETAILED DESCRIPTION

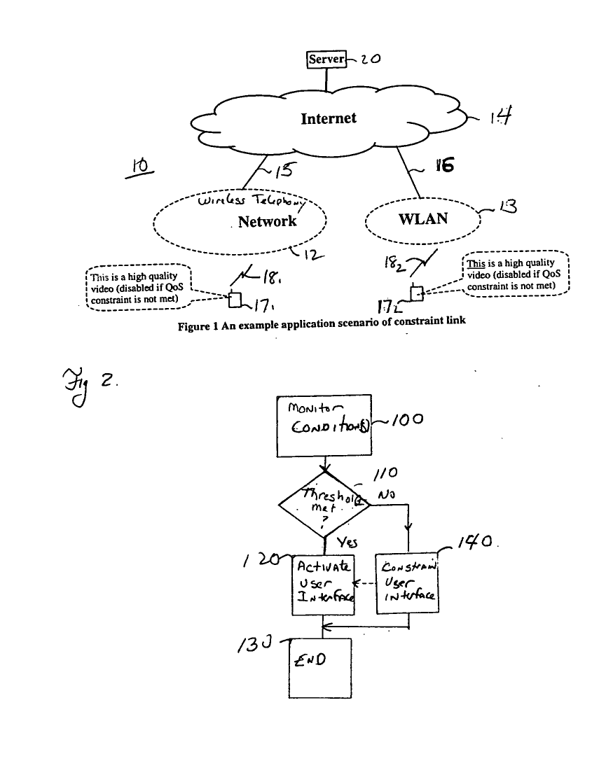

FIG. 1 depicts a communications system 10 that includes at least one, and preferably, a plurality of radio access networks, illustratively depicted by a cellular network 12 and a wireless Local Area Network (LAN) 13, respectively, interworked through a data network 14, such as the Internet. Communications links 15 and 16 connect the Internet 14 to the wireless network 12 and wireless LAN 13, respectively. The wireless network 12 and the wireless LAN 13 provide access to at least one, and preferably, a plurality of mobile terminal users, illustratively depicted by users 17₁ and 17₂. As shown in FIG. 1, the mobile terminal user 17₁ accesses the wireless telephony network 12 via a radio link 18, while the mobile terminal user accesses the wireless LAN 13 via radio link 18₂. Co-pending U.S. patent application Ser. No. 10/186,019, filed on Jun. 28, 2002, and assigned to the present assignee Thomson Licensing S.A., (incorporated by reference herein), discloses an exemplary embodiment of the wireless telephony network 12 and the wireless LAN 13.

In practice, the wireless telephony network 12 and the wireless LAN 13 each support various applications. To execute a desired application, a mobile terminal user, such as one of users 17₁ and 17₂, activates a user interface, for example, a hyperlink (not shown) on the display screen of the user's mobile terminal (not shown). In the some instances, the application might not reside in the network itself, in which case, the network will access a server 20 through the Internet 14 to obtain the desired application. Thus for example, to obtain access to a streaming video segment, the mobile terminal user 17₁ will activate a hyperlink, causing the wireless telephony network 12 to access the server 20 and obtain therefrom the requested streaming video segment.

Heretofore, no constraint existed on activation of a user interface, (e.g., a hyperlink) associated with user-selected application. Thus, a user could activate a user interface even if certain conditions existed, such as insufficient bandwidth that would adversely impact execution of the application. In accordance with present principles, there is provided a technique for a constraining user interface, such as a hyperlink, in accordance with current resources and/or specific user requirements. FIG. 2 illustrates in flow chart form the steps of the method for constraining a user interface. The method of FIG. 2 commences upon execution of step 100 during which monitoring occurs of at least one condition of interest that will potentially impact some aspect of the user-selected application. For example, the monitored condition could comprise actual communication link bandwidth, which could fall low enough to impair execution of a selected application such as streaming video. Another monitored condition could comprise maximum link bandwidth. For certain applications, the maximum communication link bandwidth might not support to selected application.

Access cost typically comprises another condition that will impact execution of the selected application via a corresponding user interface. Many providers of wireless service impose different access charges depending on a variety of conditions, such as requested bandwidth, time of day, and day of the week, to name just a few. In some instances, a mobile terminal user may not fully appreciate that selecting a particular application will necessitate use of a high bandwidth link to support that application. Thus, selecting such an application could incur significant access charges unknown to the mobile terminal use at the time of application selection. Therefore, access cost could also comprise a condition monitored during step 100 in place of, or in addition to, actual bandwidth. Other conditions can also warrant monitoring during step 100. For example, satisfactory execution of a selected application might require that the user's terminal have certain capability in terms of hardware and/or software. Thus, the monitoring step performed during step 100 could include determining whether the user's terminal has the requisite capability required by the selected application.

During step 100, monitoring occurs of at least one of the above-described conditions. Indeed several conditions could undergo monitoring simultaneously during step 100. Deciding which conditions warrant monitoring becomes a matter of design choice. The degree to which a particular condition influences execution of the selection application will affect selection of which conditions will undergo monitoring. The monitoring performed during step 100 typically occurs within the radio access network providing radio access, such one of the wireless telephony network 12 or the wireless LAN 13. Depending on its sophistication and capability, the user's terminal could perform the monitoring undertaken during step 100. Indeed, the monitoring could involve action by both the network and the user's terminal.

Following step 100, a check occurs during step 110 to determine whether the monitored condition falls within a prescribed threshold. For example, if the monitored condition comprises network bandwidth, the threshold will typically correspond to the minimum bandwidth required for successful application execution. If the monitored condition comprises access cost, the threshold corresponds to the maximum access charge acceptable to the mobile terminal user. Thus, the threshold against which the monitored condition is compared during step 110 will typically correspond to the boundary value for the condition.

Upon determining that each condition of interest, as monitored during step 100, falls within the threshold during step 110, then program execution branches to step 120 during the user interface(s) associated with the selected application become active. Thus, for example if the condition monitored during step 100 comprises actual bandwidth and the actual bandwidth exceeds the minimum value requires for the selected application, as determined during step 110, then the hyperlink associated with the application selected by the user, becomes active, allowing the user to select the application. Thereafter, the method ends (step 130).

During execution of step 110, the monitored condition might fall outside its corresponding threshold. Thus, for example, the actual bandwidth might not at least equal the bandwidth required for the selected application or the actual access charge might exceed the charge authorized by the mobile terminal user. Under such circumstances, program execution branches to step 140 rather than step 120. During execution of step 140, the user interface(s) (e.g., the hyperlinks(s)) associated with the user-selected application now become constrained, either partially or completely. A completely constrained user interface becomes disabled, precluding actuation by the user. In practice, a display message will accompany the disablement of the user interface to alert the mobile terminal user of his/her inability to actuate that user interface. The message could include the reason why the user cannot actuate the user interface, such as insufficient bandwidth or an excessive access charge. Following step 140, program execution ends (step 130). Rather than completely constrain the user interface during step 140, the user interface could become partially constrained. For example, in the event the actual access change exceeds a prescribed maximum amount, the mobile terminal user still activate the associated user interface (hyperlink) by specifically confirming her/her willingness to absorb the higher cost.

Disablement and controlled activation comprise two separate mechanisms for enforcing constraints on a user interface. When the user's terminal receives a page of information downloaded by the server 14, all the hyperlinks inside the page undergo analysis to evaluate constraints associated with each hyperlink. Upon establishing that one or more conditions warrant constraining a hyperlink, then that link becomes disabled and an appropriate message appears on the user's terminal indicating that the link has been disabled. A change in conditions, as could occur when the mobile terminal user transitions to the wireless LAN 13 from the wireless telephony network 12, will trigger the reevaluation of one or more hyperlinks and some of hyperlinks may now become enabled.

As indicated, controlled activation constitutes another mechanism for constraining a hyperlink. Rather than disable a hyperlink in advance, a mobile terminal user's attempt to actuate a hyperlink will trigger evaluation of the constraints if any on that hyperlink. If a constraint exists, (i.e., the monitored condition does falls outside its corresponding threshold), the link is not activated. The user may receive a notification concerning the reason the inability to activate the hyperlink. The user's terminal can record the activation attempt. Upon a change in conditions that no longer warrant constraining the hyperlink, the user will receive a notification that the link has become active.

As an example, the following code segment illustrates a constrained hyperlink written in HTML. (Note that the HTML extension tags are just for illustration purposes, they are not part of the standard.)

<A HREF=“http://www.technicolor.com/video/enews.mpg”>

Entertainment News
<Constraints>

<MinRate> 80 </MinRate>
<MeanRate> 100 </MeanRate>
<Action> Disable </Action>

</Constraints>

</A>

This hyperlink specifies a constraint that requires at least a minimum rate of 80 Kbps and a mean rate of 100 Kbps. The Action item specifies disabling the hyperlink upon a failure to meet the specified constraints. The rest of the tags are regular HTML tags, which specify a link http://www.technicolor.com/video/enews.mpg with the text “Entertainment News”. When this HTML page is displayed in a browser, depending on the various parameters that affect the constraints (e.g. whether the throughput of the network access meets the required rates), the link may be enabled or disabled.

The foregoing describes a technique for controlling a user interface such as a hyperlink, in accordance with one or more constraints.

1. A method for controlling the activation of at least one user interface via which a user selects an application for execution, comprising the steps of:
monitoring at least one condition that might potentially impact performance of the application;
determining if the monitored condition is met and if so then
constraining the one user interface by selectively controlling a hyperlink to control user selection of the application.

2. The method according to claim 1 wherein the monitoring step comprises:
monitoring the one condition in a communications network accessed by the user to obtain the application.

3. The method according to claim 1 wherein the monitoring step comprises:
monitoring the one condition in a mobile terminal via which the user obtains the application.

4. The method according to claim 1 wherein the monitoring step comprises:
monitoring actual bandwidth of a communications network accessed by the user to obtain the application.

5. The method according to claim 1 wherein the monitoring step comprises:
monitoring an access charge imposed by a communications network accessed by the user to obtain the application.

6. The method according to claim 1 wherein the step of constraining the one user interface comprises the step of completely constraining the one user interface to disable activation.

7. The method according to claim 1 wherein the step of constraining the one user interface comprises the step of partially constraining the user to limit activation.

8. The method according to claim 1 wherein the step of constraining the one user interface comprises the step of partially constraining the user to delay activation

9. The method according to claim 6 further comprising the step of displaying a message concerning disablement of the user interface.

10. The method according to claim 7, further comprising the step of displaying a message concerning limiting of the user interface.

11. A system for controlling the activation of at least one user interface via which a user selects an application for execution, comprising the steps of:
means for monitoring at least one condition that might potentially impact performance of the application;
means for determining if the monitored condition falls outside a corresponding threshold; and
means for constraining the one user interface by selectively controlling a hyperlink to control user selection of the application.

12. The system according to claim 11 wherein the monitoring means monitors the one condition in a communications network accessed by the user to obtain the application.

13. The system according to claim 11 wherein the monitoring means comprises a mobile terminal via which the use obtains the application.

14. The system according to claim 11 wherein the monitoring means monitors actual bandwidth of a communications network accessed by the user to obtain the application.

15. The system according to claim 11 wherein the monitoring means monitors an access charge imposed by a communications network accessed by the user to obtain the application.

16. The system according to claim 11 wherein constraining means completely constrains the one user interface to disable activation.

17. The system according to claim 11 wherein the constraining means partially constrains the user interface to limit activation.
